(19) United States
(12) Patent Application Publication
(10) Pub. No.: US 2025/0216761 A1
(43) Pub. Date: Jul. 3, 2025

(54) SCREEN AND PRODUCTION METHOD THEREOF, AND DIE

(71) Applicant: DEXERIALS CORPORATION, Tochigi (JP)

(72) Inventors: Kazuo GOTO, Tochigi (JP); Yasuyuki KUDO, Tochigi (JP); Tatsuya HARIMA, Tochigi (JP); Katsuhiro DOI, Tochigi (JP); Kazuhiko NODA, Tochigi (JP); Kouichi OGAWA, Tochigi (JP)

(21) Appl. No.: 18/852,795

(22) PCT Filed: Apr. 11, 2023
(86) PCT No.: PCT/JP2023/014787

§ 371 Date: Sep. 30, 2024

(30) Foreign Application Priority Data
Apr. 15, 2022 (JP) 2022-067329

(51) Int. Cl. G03B 21/60; G02B 27/18

(52) U.S. Cl. CPC G03B 21/60; G02B 27/18

(57) ABSTRACT

A screen is configured to receive and reflect projected light at a light-receiving surface in a state in which the screen is placed upright. The screen includes the light-receiving surface. The light-receiving surface includes a mirror array A in which multiple mirrors A are arranged in a first direction, and a mirror array B that is positioned in a second direction crossing the first direction and in which multiple mirrors B are arranged in the first direction. The mirrors A and the mirrors B are tilted in the same direction at the light-receiving surface.

### TECHNICAL FIELD

The present invention relates to a screen and a production method of the screen, and a die.

### BACKGROUND ART

In recent years, short-throw projectors with a projection distance of several tens of centimeters have been put into practice, and large-screen displays have become possible. Such short-throw projectors have the following issues. Specifically, the distance between a light source and a given site in the screen is varied from location to location. Electrical correction is desirable because reflected light is reduced toward the ends of the screen when using a typical light source, which causes leakage of rays of light to the surroundings. Improvement might be achievable when using, for example, a laser light source with small diffusivity as the light source. However, the incident angle changes greatly, and thus adverse effects caused thereby are unavoidable.

Meanwhile, for large-screen displays, it is also an issue to attempt to widen the viewing angle as well as increasing the front luminance. With a method of using a diffusion surface or a diffusion layer, the viewing angle becomes wider, but the front luminance is sacrificed. Therefore, in order to ensure the front luminance in the screen for the short-throw projector, a Fresnel mirror with a light source position as the focal point is used.

As such a Fresnel mirror, for example, a reflective screen is proposed (see, for example, Patent Document 1). This proposed reflective screen is increased in the front luminance by processing the reflective surface into the form of a Fresnel mirror, and also takes measures against external light. In this proposal, a light source is disposed at the focal position of the Fresnel mirror, thereby converting light emitted from the light source into parallel light. Also, as the measures against external light, the non-reflective surface of the Fresnel mirror is utilized such that the light striking the non-reflective surface does not return to the front surface.

### RELATED ART DOCUMENTS

### Patent Documents

Patent Document 1: Japanese Patent No. 6272013

### SUMMARY OF THE INVENTION

### Problems to be Solved by the Invention

However, as illustrated in FIG. 1, the above proposed Fresnel mirror has a shape in which a plurality of unit lenses 131 are arranged concentrically about a point C, and is therefore typically produced through processing in the circumferential direction. Although such processing in the circumferential direction can form different shapes in the circumferential direction, it is demanding to form different shapes in directions other than the circumferential direction. Also, it is challenging for the above proposed Fresnel mirror to both increase the front luminance and widen the viewing angle in the horizontal direction. Thus, as illustrated in FIG. 2, an attempt to widen the viewing angle is made by providing a diffusion layer 141 on the observers' side (image source side) of a lens layer 13 and a reflective layer 12. However, when the diffusion layer 141 is provided, light is diffused twice at the time of incidence and at the time of reflection, leading to reduction in utilization efficiency of rays of light. In addition, a layer configuration becomes complicated, leading to reduction in the degree of freedom in the design of the screen.

The above proposed Fresnel mirror includes, in order from the image source side (observers' side) thereof: a surface optical layer 15 including a unit prism 151; a base layer 14 including a light diffusion layer 141 and a colored layer 142; a lens layer 13 including a unit lens 131, a lens surface 132, and a non-lens surface 133; a reflective layer 12; a protective layer 11; and the like.

The present invention aims to address the above issues and achieve the following object. That is, it is an object of the present invention to provide: a screen that is high in front luminance, is excellent in external light control and in processability, and is able to widen the viewing angle; a die for use in the production of the screen; and a production method of the screen.

### Means for Solving the Problems

Means for addressing the above issues are as follows.

<1> A screen configured to receive and reflect projected light at a light-receiving surface in a state in which the screen is placed upright, the screen including:
the light-receiving surface that includes
   a mirror array A in which multiple mirrors A are arranged in a first direction, and
   a mirror array B that is positioned in a second direction crossing the first direction and in which multiple mirrors B are arranged in the first direction, and
the mirrors A and the mirrors B are tilted in the same direction at the light-receiving surface.

<2> The screen according to <1> above, in which
the mirror array A, the mirror array B, or both are extended to vicinities of both ends of the light-receiving surface in the first direction.

<3> The screen according to <1> or <2> above, in which
in a state in which the mirror array A is positioned at one end in the second direction, and the mirror array B is positioned at another end in the second direction, the another end being opposite to the one end,
a tilt of the mirrors B in the mirror array B is greater than that of the mirrors A in the mirror array A.

<4> The screen according to <1> or <2> above, in which
the mirrors A, the mirrors B, or both include a mirror surface disposed at a surface of a support, and
the support is visible in a state in which the light-receiving surface is seen from another end in the second direction.

<5> The screen according to <4> above, in which
the mirrors positioned at both ends, in the first direction, of the mirror array A, the mirror array B, or both are tilted toward the ends, and
the support is visible in a state in which the light-receiving surface is seen from one end in the first direction.

<6> The screen according to any one of <1> to <5> above, in which
the mirrors A, the mirrors B, or both are rectangular.

<7> The screen according to any one of <1> to <6> above, in which
the mirrors A and the mirrors B are arranged in a lattice form.

<8> The screen according to any one of <1> to <7> above, in which
the mirrors A, the mirrors B, or both are a plane mirror, a concave mirror, or a convex mirror.

<9> The screen according to any one of <1> to <8> above, in which
surface areas of the mirrors A, the mirrors B, or both are 300 μm² or more and 4 mm² or less.

<10> The screen according to any one of <1> to <9> above, in which
the screen is for a short-throw projector.

<11> A die for use in production of the screen according to any one of <1> to <10> above, the die including:
an imprinting plane array A including multiple imprinting planes A in the first direction, where the multiple imprinting planes A are configured to form planes by imprinting, and the mirrors A are to be disposed on surfaces of the planes; and
an imprinting plane array B including multiple imprinting planes B in the second direction crossing the first direction, where the multiple imprinting planes B are configured to form planes by imprinting, and the mirrors B are to be disposed on surfaces of the planes, in which
the imprinting planes A and the imprinting planes B are tilted in the same direction.

<12> The die according to <11> above, in which
the die has a roll shape,
the first direction is an axial direction, and
the second direction is a circumferential direction.

<13> A production method of a screen, the production method including:
imprinting the die of <11> or <12> above to a surface of a base.

### Advantageous Effects of the Invention

According to the present invention, it is possible to solve the above issues in the art and achieve the above object. The present invention can provide: a screen that is high in front luminance, is excellent in external light control and in processability, and is able to widen the viewing angle; a die for use in the production of the screen; and a production method of the screen.

### BRIEF DESCRIPTION OF THE DRAWINGS

FIG. 1 is a schematic view of a lens layer of an existing Fresnel mirror when the rear surface of the lens layer is seen in a front direction.

FIG. 2 is a schematic cross-sectional view of an existing Fresnel mirror.

FIG. 3 is a schematic view illustrating an example of a screen of the present invention.

FIG. 4 is a schematic view illustrating an angle of reflection by the screen of the present invention.

FIG. 5 is a schematic perspective view illustrating an example of the screen of the present invention.

FIG. 6A is a schematic perspective view illustrating an example of frontward reflection in the screen of the present invention.

FIG. 6B is a schematic perspective view illustrating an example of backward reflection in the screen of the present invention.

FIG. 7A is a schematic view illustrating an example of an arrangement of mirrors in the screen of the present invention.

FIG. 7B is a schematic view illustrating another example of an arrangement of mirrors in the screen of the present invention.

FIG. 8A is a schematic view illustrating an example of a planar shape of a mirror in a screen of the present invention.

FIG. 8B is a schematic view illustrating another example of the planar shape of the mirror in the screen of the present invention.

FIG. 8C is a schematic view illustrating another example of the planar shape of the mirror in the screen of the present invention.

FIG. 8D is a schematic view illustrating another example of the planar shape of the mirror in the screen of the present invention.

FIG. 8E is a schematic view illustrating another example of the planar shape of the mirror in the screen of the present invention.

FIG. 8F is a schematic view illustrating another example of the planar shape of the mirror in the screen of the present invention.

FIG. 8G is a schematic view illustrating another example of the planar shape of the mirror in the screen of the present invention.

FIG. 8H is a schematic view illustrating another example of the planar shape of the mirror in the screen of the present invention.

FIG. 9A is a schematic view illustrating an example of the shape of the cross section of the mirror in the screen of the present invention.

FIG. 9B is a schematic view illustrating another example of the shape of the cross section of the mirror in the screen of the present invention.

FIG. 9C is a schematic view illustrating another example of the shape of the cross section of the mirror in the screen of the present invention.

FIG. 10A is a schematic view illustrating an example of the shape of the side surface of the screen of the present invention.

FIG. 10B is a schematic view illustrating another example of the shape of the side surface of the screen of the present invention.

FIG. 10C is a schematic view illustrating another example of the shape of the side surface of the screen of the present invention.

FIG. 11 is a schematic perspective view illustrating an example of a roll-shaped die of the present invention.

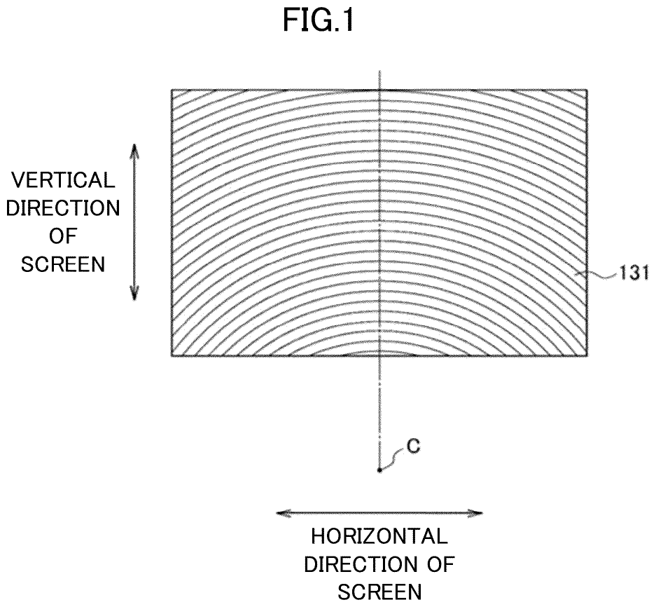

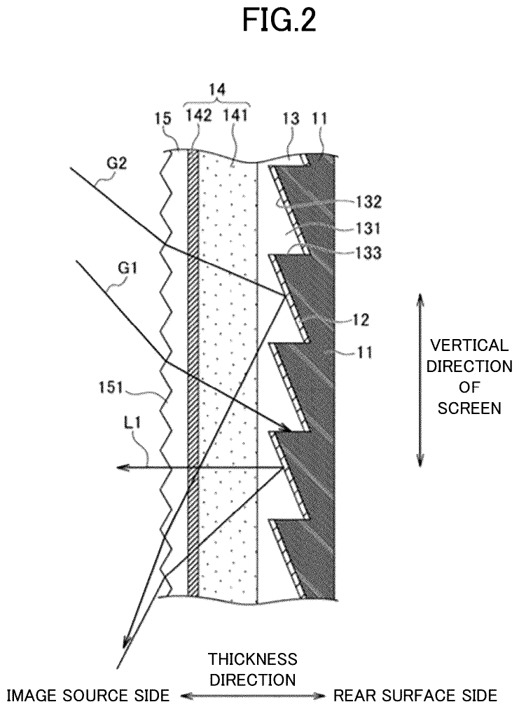

### DETAILED DESCRIPTION OF THE INVENTION

### Screen

A screen of the present invention is configured to receive and reflect projected light at a light-receiving surface in a state in which the screen is placed upright. The screen includes the light-receiving surface. The light-receiving surface includes a mirror array A in which multiple mirrors A are arranged in a first direction, and a mirror array B that is positioned in a second direction crossing the first direction and in which multiple mirrors B are arranged in the first direction. The mirrors A and the mirrors B are tilted in the same direction at the light-receiving surface.

The screen of the present invention has the functions of receiving and reflecting the projected light at the light-receiving surface in the state in which the screen is placed upright.

The “screen configured to receive and reflect projected light at a light-receiving surface” means what is referred to as a “reflective screen”.

No particular limitation is imposed on the light projected to the light-receiving surface. The light may be projected to the light-receiving surface from below, or may be projected to the light-receiving surface from above. Alternatively, the light may be projected to the light-receiving surface in the horizontal direction. When the light is projected to the light-receiving surface from below, there is an advantage that a light source can be readily disposed.

The light is emitted from a light source. No particular limitation is imposed on the light source, which may be appropriately selected in accordance with the intended purpose. Examples of the light source include a lamp, a laser, and the like. As the laser, blue, green, and red lasers may be provided. Alternatively, yellow, green, and red colors may be produced by irradiating a phosphor with blue laser beams.

In the case of screens for short-throw projectors, the light source is an imaging light projection device, called a projector, configured to project imaging light that forms an image toward the screen.

No particular limitation is imposed on the light, which may be appropriately selected in accordance with the intended purpose. In the case of screens for short-throw projectors, the light is imaging light that forms an image emitted from a projector serving as a light source. Also, in the case of screens for reflecting mirrors, the light is artificial light, such as sunlight, illumination light, or the like.

No particular limitation is imposed on the light-receiving surface, which may be appropriately selected in accordance with the intended purpose as long as the light-receiving surface can receive projected light. In the case of screens for short-throw projectors, the light-receiving surface is a display screen or the like. In the case of screens for reflecting mirrors, the light-receiving surface is a typical reflecting surface.

The screen of the present invention includes: a support; a mirror array A in which multiple mirrors A are arranged on the support in a first direction; and a mirror array B that is positioned in a second direction crossing the first direction and in which multiple mirrors B are arranged in the first direction. The screen of the present invention further includes other layers, if necessary.

The multiple mirrors A are preferably arranged in a straight line from the viewpoint of processability. Also, the first direction and the second direction are preferably orthogonal to each other from the viewpoint of processability. Further, the multiple mirrors B are preferably arranged in a straight line in the first direction from the viewpoint of processability.

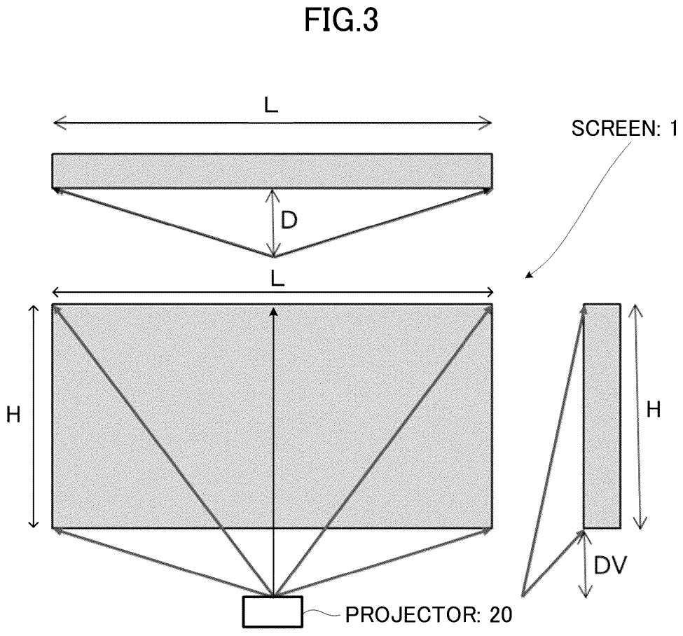

As illustrated in FIG. 3, a projection device including the screen of the present invention includes: a screen 1 that is placed upright; and a projector 20 that serves as a light source configured to project imaging light to the screen 1. The projector 20 is a short-throw projector. The projector 20 is disposed at a position below the screen 1, for example, several tens of centimeters away from a light-receiving surface 2 of the screen 1. In an example in which a screen equivalent to 100 inches is projected from below, a width L of the screen is 2,154 mm, a height H of the screen is 1,346 mm, a distance D between the light source and the light-receiving surface is 300 mm, and a distance DV between the light source and the screen is 300 mm.

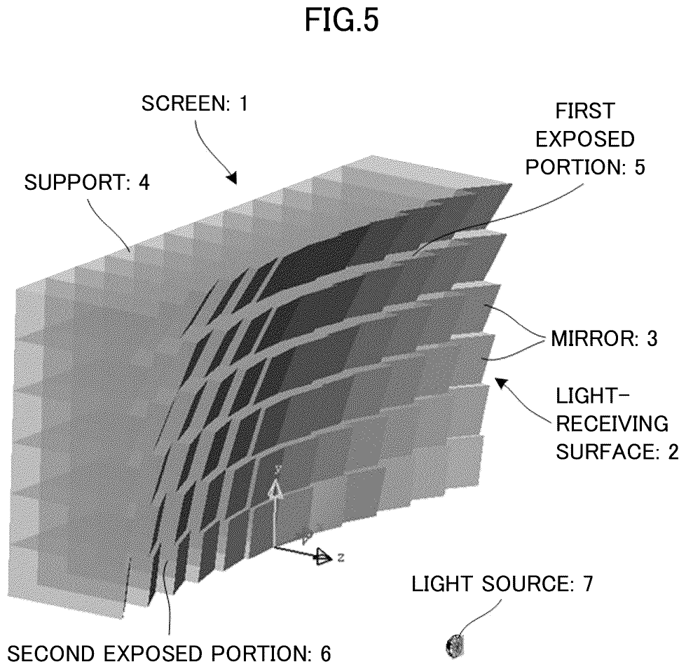

FIG. 5 is a schematic perspective view illustrating an example of the screen of the present invention. In the screen 1 of FIG. 5, multiple mirrors 3 (mirrors A and mirrors B) are arranged at the surface of a support 4, thereby forming the light-receiving surface 2. In FIG. 5, reference numeral 5 denotes a first exposed portion of the support 4 that is exposed when the light-receiving surface is seen from above the screen, and reference numeral 6 denotes a second exposed portion of the support 4 that is exposed when the light-receiving surface is seen laterally of the screen. Reference numeral 7 denotes a light source.

### Mirrors A and Mirrors B

The multiple mirrors A and the multiple mirrors B are arranged at the surface of the support.

No particular limitation is imposed on the shape, size, number, arrangement, structure, and the like of the mirrors A and the mirrors B, which may be appropriately selected in accordance with the intended purpose.

No particular limitation is imposed on the planar shape of the mirrors A, the mirrors B, or both, which may be appropriately selected in accordance with the intended purpose. Examples of the planar shape include: a circle, an ellipse, polygons (e.g., a triangle, a quadrangle, a pentagon, a hexagon, a heptagon, an octagon, and the like), a rectangle, a square, a rhombus, a trapezoid, a random irregular shape, and the like. These may be used alone or in combination. Of these, a rectangle is preferable from the viewpoint of cutting processability.

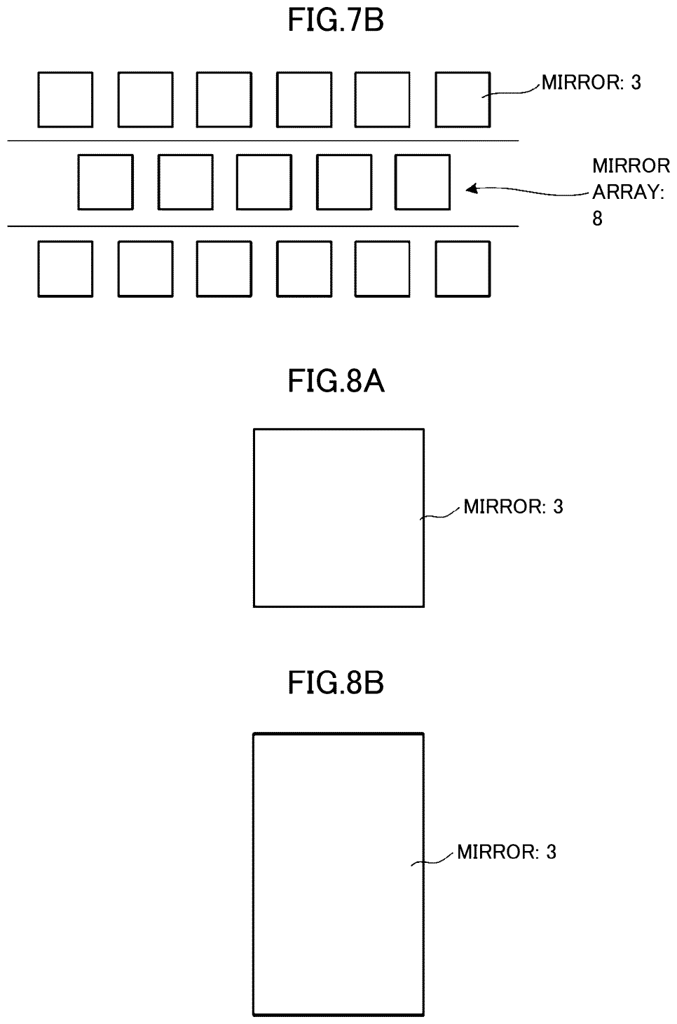

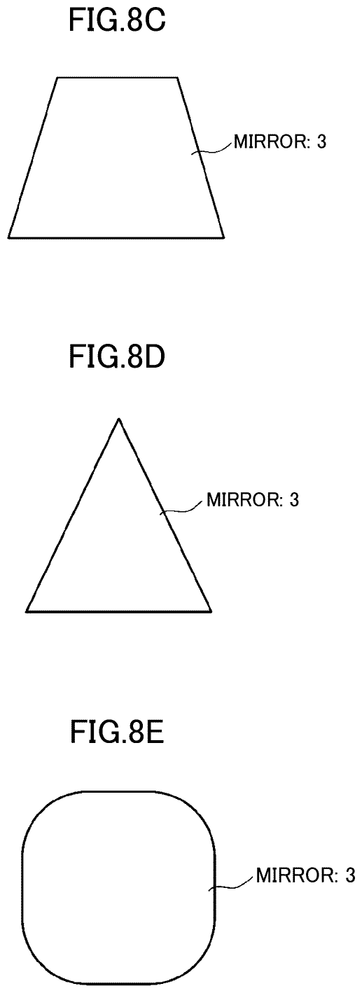

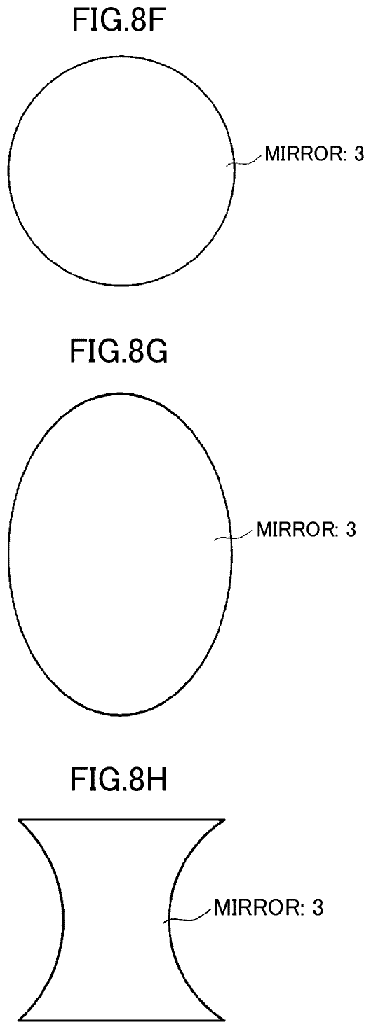

Specifically, the mirrors A and the mirrors B can have planar shapes as illustrated in FIGS. 8A to 8H. These may be appropriately used in combination.

No particular limitation is imposed on the number of the mirrors A in the mirror array A or on the number of the mirrors B in the mirror array B. The number of the mirrors A or the mirrors B may be appropriately selected, for example, in accordance with the size of the screen. However, the number of the mirrors A or the mirrors B is preferably 100 or more, more preferably 1,000 or more, further preferably 2,000 or more, and especially preferably 5,000 or more. No particular limitation is imposed on the upper limit of the number of the mirrors A in the mirror array A or the number of the mirrors B in the mirror array B. The upper limit of the number of the mirrors A in the mirror array A or the number of the mirrors B in the mirror array B may be appropriately selected, for example, in accordance with the size of the screen. The upper limit thereof is preferably 20,000 or less.

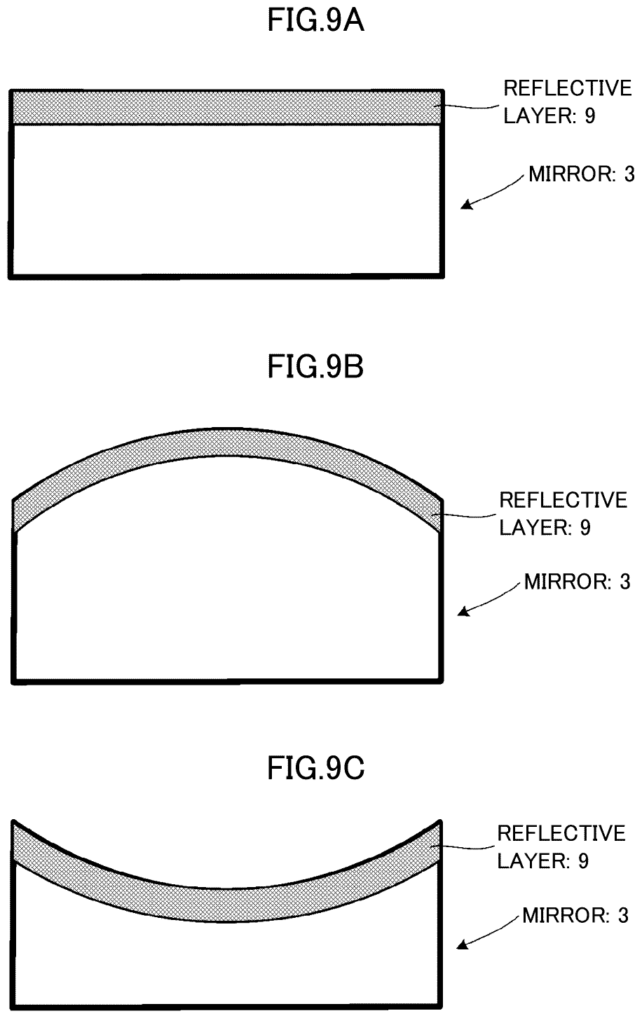

From the viewpoint of processability, the mirrors A, the mirrors B, or both are preferably a plane mirror as illustrated in FIG. 9A. The plane mirror having a flat surface readily imparts a shape having a surface diffusion effect. Also, as the direction of the shaping and the direction of the diffusion shape are orthogonal or parallel to each other, processing is readily performed.

In addition to the plane mirror illustrated in FIG. 9A, a convex mirror illustrated in FIG. 9B or a concave mirror illustrated in FIG. 9C may be employed.

The convex mirror (dome shape) illustrated in FIG. 9B is preferable from the viewpoint of the ability to diffuse light characteristically in the horizontal direction.

As illustrated in FIGS. 9A to 9C, the mirrors A, the mirrors B, or both include a reflecting layer 9 at the outermost surface thereof.

The reflecting layer 9 is formed of a highly reflective material through electrolytic plating, electroless plating, coating or vapor deposition, sputtering, a method of imprinting a metal foil, or the like.

As the highly reflective material, a material having a high reflectance in the visible light region is used. Examples of the material include aluminum, silver, gold, platinum, bismuth, nickel, tin, alloys thereof, and the like.

In the screen of the present invention, it is not necessary to form a reflecting layer at a surface other than a region that is mainly used as a reflecting surface. When the screen includes a surface on which no reflecting layer is formed, incident light other than the light to be projected can be transmitted, and light scattering due to external light can be suppressed.

The surface areas of the mirrors A, the mirrors B, or both are preferably 300 μm² or more and 4 mm² or less, and more preferably 0.003 mm² or more and 0.05 mm² or less.

The surface areas can be measured, for example, by observing the mirrors A and the mirrors B with an optical microscope and determining dimensions thereof.

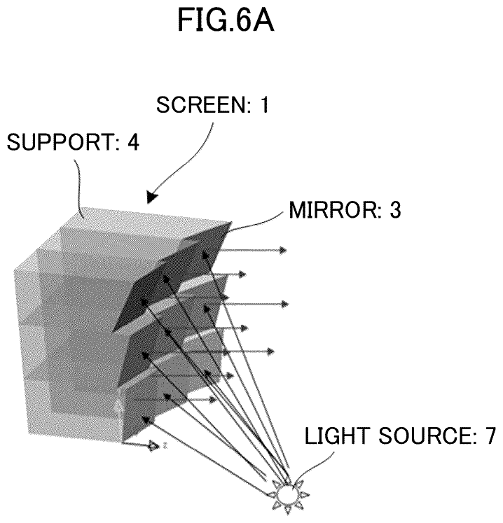

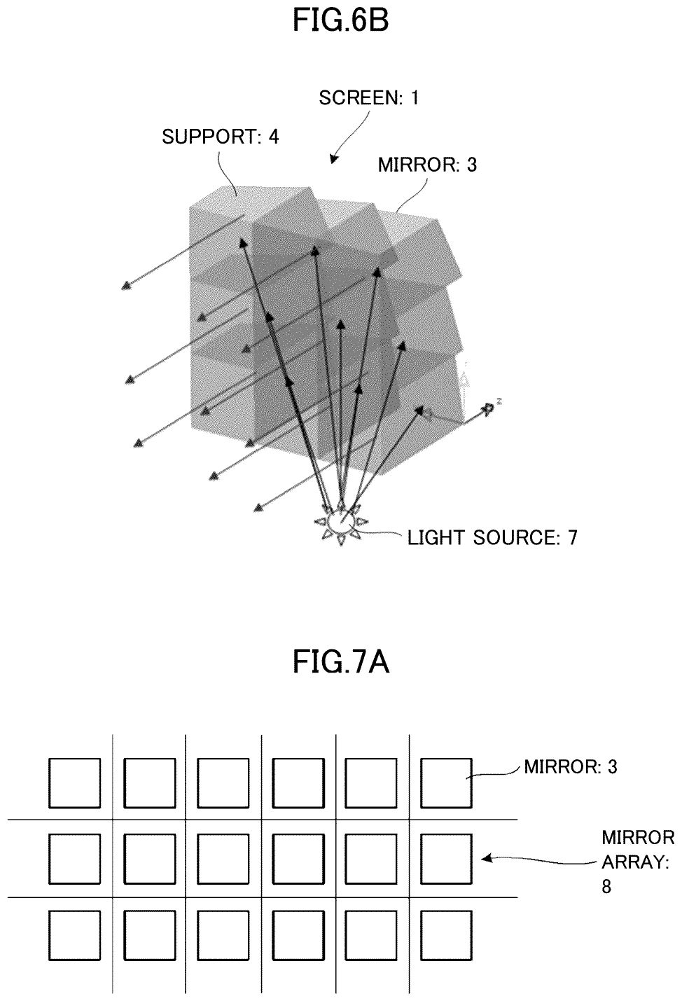

As illustrated in FIG. 6A, the multiple mirrors A and the multiple mirrors B are arranged at the frontmost surface of the screen 1 in order to increase the front luminance (frontward reflection). Meanwhile, as illustrated in FIG. 6B, the multiple mirrors A and the multiple mirrors B can increase the front luminance even if arranged at the back surface via a transmissive support 4 formed of a resin transparent to the wavelength of light to be transmitted, in order to protect the surface shape of the screen 1 (backward reflection).

In the case of the backward reflection illustrated in FIG. 6B, the support 4 may be optically transparent to an image to be projected. Also, the support 4 may be colored so as to absorb light that should not be reflected toward viewers. The visible light transmittance thereof is preferably 90% or more. In the case of the frontward reflection illustrated in FIG. 6A, light does not need to be transmitted through the support 4, and thus the support 4 need not be transparent and may be opaque or colored.

As illustrated in FIG. 3, the first direction in which the multiple mirrors A and the multiple mirrors B are arranged in a straight line means a width direction L of the screen 1. The second direction orthogonal to the first direction means a height direction H of the screen 1.

The “mirrors A” in the “mirror array A” and the “mirrors B” in the “mirror array B” are preferably arranged in a lattice form illustrated in FIG. 7A. As illustrated in FIG. 7B, the mirrors are arranged in a straight line in the “first direction” (the width direction of the screen). However, embodiments in which the mirrors are not arranged in a straight line in the “second direction” (the height direction of the screen) are encompassed.

The mirror array A and the mirror array B may be arranged to be next to and in contact with each other, or may be arranged apart from each other with a predetermined gap.

No particular limitation is imposed on the number of the mirror arrays in the screen, which may be appropriately selected, for example, in accordance with the size of the screen. However, the number of the mirror arrays in the screen is preferably 50 or more, more preferably 100 or more, further preferably 500 or more, and especially preferably 1,000 or more.

No particular limitation is imposed on the upper limit of the number of the mirror arrays in the screen, which may be appropriately selected, for example, in accordance with the size of the screen. However, the upper limit thereof is preferably 20,000 or less.

The screen of the present invention is a collection of the multiple mirrors A and the multiple mirrors B, and the mirrors A and the mirrors B are tilted in the same direction at the light-receiving surface. This forms a screen including a single large reflecting surface that is set at an appropriate angle. The formed screen can reflect light of various incident angles emitted from a light source, to the front surface on the viewers' side with high luminance.

Here, “the mirrors A and the mirrors B are tilted in the same direction” means that the mirrors A and the mirrors B are tilted in the same direction at a predetermined angle, i.e., the mirrors A and the mirrors B are tilted at predetermined angles in the horizontal and vertical directions.

The state in which “the mirrors A and the mirrors B are tilted in the same direction” can be confirmed by either or both of: a method of confirming that when parallel rays of light are incident on the screen in the front direction of the screen, the parallel rays of light are converged to a predetermined focal position (i.e., the position of the light source); and a method of confirming that when the screen is irradiated with a beam of light from the position of the light source, the reflected light is observed only at the front surface of the screen at a narrow light-receiving angle over the entirety of the screen.

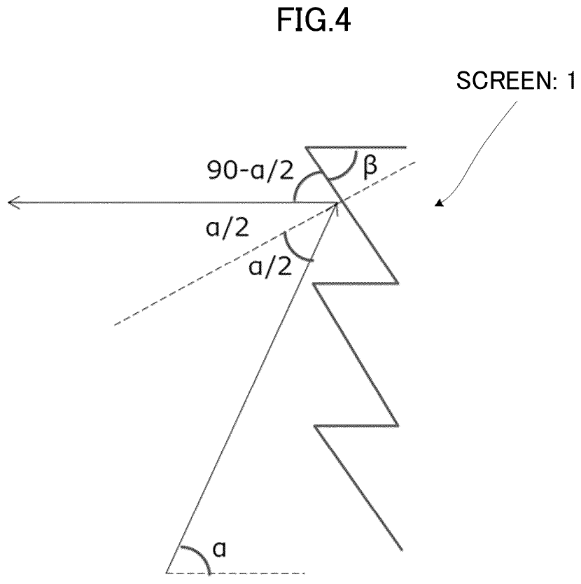

FIG. 4 is related to the angle of “tilt” of the mirrors A and the mirrors B. Specifically, when rays of light incident from below at an angle of a are reflected by the screen 1 to the front surface, the angle α in the vertical direction is from 45 degrees through 78 degrees, and thus a tilt surface angle β is in the range of from 67.5 degrees through 51 degrees. Also, the angle α in the horizontal direction is from 0 degrees through 74 degrees, and thus the tilt surface angle β is in the range of from 90 degrees through 53 degrees.

According to the screen of the present invention, when the relative position between the light source and the light-receiving surface is fixed, and when the positions of the multiple mirrors A and B in the light-receiving surface are determined, the incident angles of incident light in the horizontal and vertical directions are determined. When the incident angles are determined, the angles of the surfaces that reflect rays of light to the front surface are determined. By dividing the screen surface by orthogonal coordinates, and determining the angles of the reflecting surfaces of the multiple mirrors A and the multiple mirrors B, it is possible to obtain a screen including the collection of the multiple mirrors A and the multiple mirrors B as a reflecting surface relative to the light source.

### Support

No particular limitation is imposed on the material, color, shape, size, structure, and the like of the support, which may be appropriately selected in accordance with the intended purpose.

Examples of the material of the support include (meth)acrylic resins, polycarbonate resins, polystyrene resins, olefin resins, cellulose resins, tetraacetyl cellulose (TAC), polyethylene terephthalate (PET), polyphenylene sulfide (PPS), polycarbonate (PC), polyarylate (PA), polyetherimide (PEI), methyl methacrylate-styrene (MS) resins, methyl methacrylate-butadiene-styrene (MBS) resins, polyethylene naphthalate (PEN) resins, and the like. These may be used alone or in combination.

The material of the support may be not only a hard material, such as curable resins and the like, but also a soft material. When a soft material is used as the material of the screen, a flexible screen can be formed.

No particular limitation is imposed on the color of the support, which may be appropriately selected in accordance with the intended purpose. The color of the support is colorless transparent, colored transparent, colored opaque, or the like. Of these, colorless transparent is preferable.

The shape and size of the support may be appropriately selected in accordance with the shape and size of the screen.

The average thickness of the support is preferably 25 μm or more and 10,000 μm or less, and more preferably 50 μm or more and 500 μm or less. When the screen is used as a flexible screen, the average thickness of the support is preferably 25 μm or more and 200 μm.

### Other Layers

Examples of the other layers to be used if necessary include a protective layer, an anti-reflection layer, a light diffusion layer, a light absorption layer, and the like.

According to one aspect of the present invention, the mirror array A, the mirror array B, or both are extended to vicinities of both ends of the light-receiving surface in the first direction. This is preferable from the viewpoint of increasing reflection efficiency. That is, when the mirror array A, the mirror array B, or both are provided over the entire surface of the light-receiving surface in the width direction (first direction) of the screen, the projected light can be reflected at the entire surface of the light-receiving surface.

According to one aspect of the present invention, in a state in which the mirror array A is positioned at one end in the second direction, and the mirror array B is positioned at the other end in the second direction, the other end being opposite to the one end, the tilt of the mirrors B in the mirror array B is preferably greater than that of the mirrors A in the mirror array A. That is, of the mirror array A (lower side) and the mirror array B (upper side) in the height direction (second direction) of the screen, the tilt of the mirrors in the mirror array B (upper side) is preferably greater.

According to this aspect, the tilt of the mirror array increases upward in the height direction of the screen, and thus the front luminance can be increased.

According to one aspect of the present invention, the mirrors A, the mirrors B, or both include a mirror surface disposed at a surface of the support, and the support is visible in a state in which the light-receiving surface is seen from the other end in the second direction. According to this aspect, when the screen is placed upright, the mirrors are tilted downward. As a result, external light from above is absorbed by the first exposed portion of the support that is exposed when the light-receiving surface is seen from the upper side of the screen. Therefore, light scattering can be suppressed.

For example, as illustrated in FIG. 5, when the light-receiving surface 2 is seen from the other end in the height direction (second direction) of the screen 1, the support 4 is visible at a first exposed portion 5. The mirrors 3 are not disposed at the first exposed portion 5, and thus external light and the like can be absorbed. Therefore, light scattering can be suppressed.

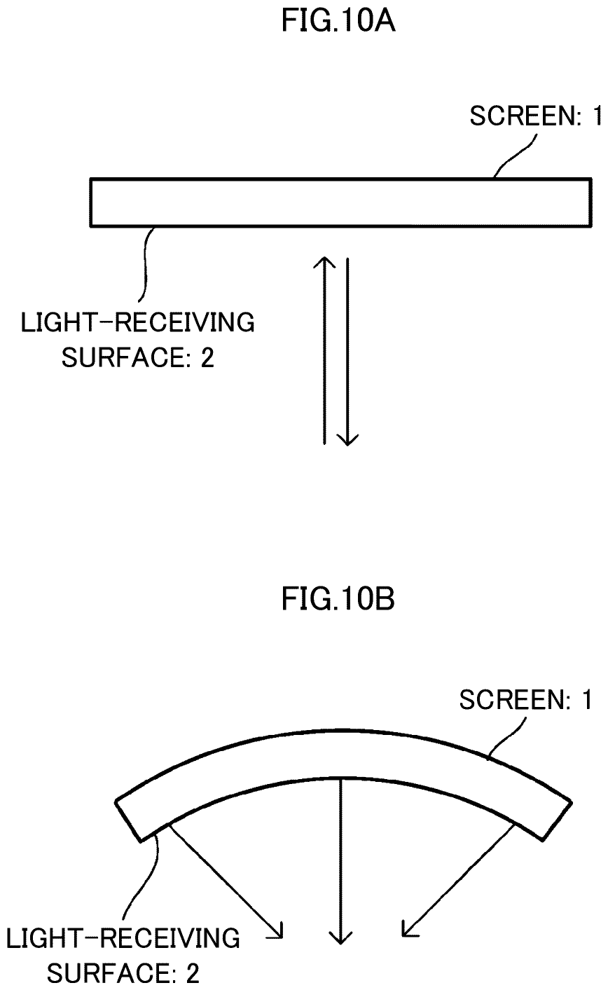

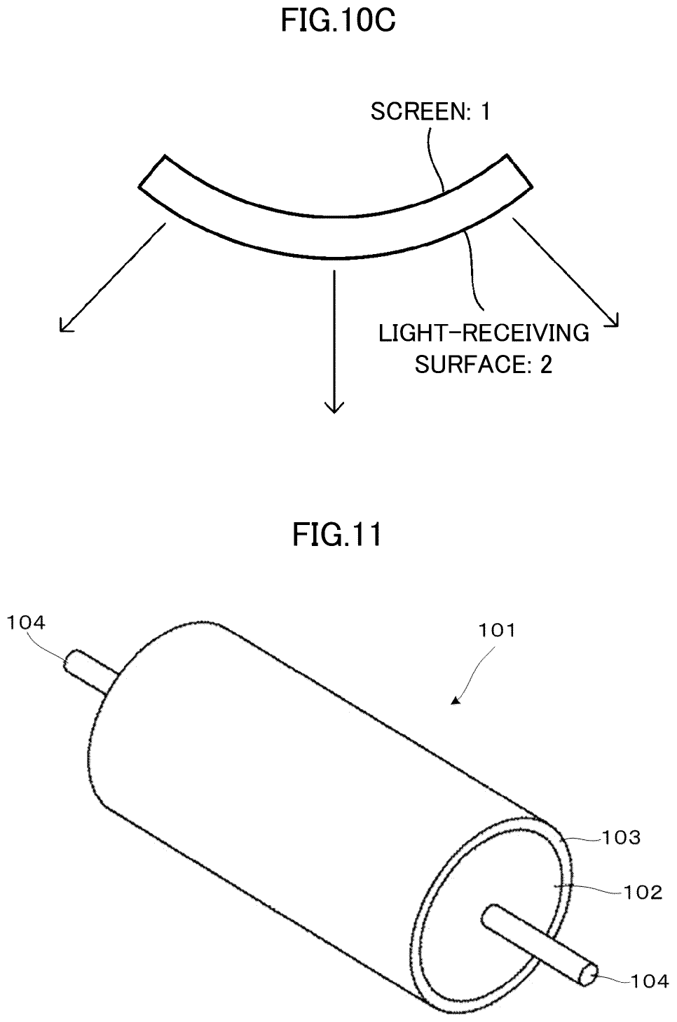

According to one aspect of the present invention, the mirrors positioned at both ends, in the first direction, of the mirror array A, the mirror array B, or both are tilted toward the ends, and the support is visible in a state in which the light-receiving surface is seen from the one end in the first direction. For example, as illustrated in FIG. 10C, when the convex light-receiving surface 2 is formed by the mirror array A, the mirror array B, or both in which the mirrors positioned at both ends are tilted toward the ends, the viewing angle can be increased compared to the flat light-receiving surface 2 of FIG. 10A and the concave light-receiving surface 2 of FIG. 10B.

When the screen is placed upright, the mirrors positioned at both ends are tilted toward the ends. Thus, the viewing angle can be widened, and external light and the like can be absorbed by a second exposed portion of the support that is exposed when the light-receiving surface is seen laterally of the screen. Therefore, lateral light scattering can be suppressed. For example, as illustrated in FIG. 5, when the light-receiving surface 2 is seen from the other end in the width direction (first direction) of the screen, the support 4 is visible at a second exposed portion 6. The mirrors are not disposed at the second exposed portion 6, and thus external light and the like can be absorbed. Therefore, light scattering can be suppressed.

The screen of the present invention is preferably for a short-throw projector. The short-throw projector can reduce the horizontal distance from the light-emitting surface of the light source to the surface of the screen on the observers' side. Therefore, the short-throw projector does not require a large disposition space, and is highly convenient.

### Die

The die of the present invention is a die for use in the production of the screen of the present invention. The die of the present invention includes: an imprinting plane array A including multiple imprinting planes A in the first direction, where the multiple imprinting planes A are configured to form planes by imprinting, and the mirrors A are to be disposed on surfaces of the planes; and a imprinting plane array B including multiple imprinting planes B in the second direction crossing the first direction, where the multiple imprinting planes B are configured to form planes by imprinting, and the mirrors B are to be disposed on surfaces of the planes.

The imprinting planes A and the imprinting planes B are tilted in the same direction.

The mirrors A in the screen of the present invention are formed by the imprinting planes A.

The mirrors B in the screen of the present invention are formed by the imprinting planes B.

The imprinting plane array A is preferably arranged in a straight line from the viewpoint of processability. Also, the first direction and the second direction are preferably orthogonal to each other from the viewpoint of processability. Further, the imprinting plane array B is preferably arranged in a straight line in the first direction from the viewpoint of processability.

The imprinting planes A and the imprinting planes B can be produced, for example, by means of a cutting tool (bite), laser irradiation, ion milling, or the like. Of these, a cutting tool (bite) is preferable.

Examples of the material of the cutting tool include diamond, cemented carbide, high-speed steel, cubic boron nitride (CBN), and the like.

The screen of the present invention that is produced by the die of the present invention is formed of flat planes divided in the horizontal and vertical directions with respect to a rectangular screen. Thus, an original plate for the screen shape is readily processed.

No particular limitation is imposed on the material, shape, and size of the die, which may be appropriately selected in accordance with the intended purpose.

Examples of the material of the die include iron, aluminum, aluminum alloys, stainless steel, and the like. It is preferable to provide the surface of the die with a surface layer formed through nickel—phosphorus (Ni—P) plating, copper (Cu) plating, or the like.

No particular limitation is imposed on the size of the die, which may be appropriately selected in accordance with the size of the screen to be produced.

Examples of the shape of the die include a flat die, a stamper, a roll shape, and the like. Of these, the die preferably has a roll shape in which the first direction is an axial direction and the second direction is a circumferential direction. By using the roll-shaped die, a high-quality screen can be produced with high mass-productivity by the roll-to-roll method.

FIG. 11 is a schematic perspective view illustrating an example of the roll-shaped die of the present invention. The surface of a roll-shaped die 101 illustrated in FIG. 11 is provided with the multiple imprinting planes A and the multiple imprinting planes B, which are not illustrated. In FIG. 11, reference numeral 102 denotes a roll base body, reference numeral 103 denotes a surface layer, and reference numeral 104 denotes a shaft.

### Production Method of Screen

The production method of the screen of the present invention includes an imprinting step, and if necessary further includes other steps.

### Imprinting Step

The imprinting step is a step of imprinting the die of the present invention to a surface of a base.

The imprinting to the surface of the base may be performed one base by one base, or may be performed by continuous forming through roll imprinting using a roll-shaped die.

No particular limitation is imposed on the material, shape, size, structure, and the like of the base, which may be appropriately selected in accordance with the intended purpose.

The material of the base may be the same as the material of the support in the screen. Examples of the material of the base include (meth)acrylic resins, polycarbonate resins, polystyrene resins, olefin resins, cellulose resins, tetraacetyl cellulose (TAC), polyethylene terephthalate (PET), polyphenylene sulfide (PPS), polycarbonate (PC), polyarylate (PA), polyetherimide (PEI), methyl methacrylate-styrene (MS) resins, methyl methacrylate-butadiene-styrene (MBS) resins, polyethylene naphthalate (PEN) resins, and the like. These may be used alone or in combination.

No particular limitation is imposed on the material of the base, which may be appropriately selected in accordance with the intended purpose. The material of the base is, for example, an ultraviolet curable resin or a thermosetting resin, and is preferably a material with less shrinkage after processing.

Examples of the shape of the base include a sheet shape, a flat-plate shape, and the like.

No particular limitation is imposed on the size of the base, which may be appropriately selected, for example, in accordance with the size of the screen to be produced.

No particular limitation is imposed on the structure of the base, which may be appropriately selected in accordance with the intended purpose. The structure of the base may be, for example, a single-layered structure or a multi-layered structure.

### Other Steps

No particular limitation is imposed on the other steps, which may be appropriately selected in accordance with the intended purpose. Examples of the other steps include a curing step, a conveyance step, a drying step, and the like.

Although the embodiments of the present invention have been described in detail above, the present invention is not limited to the above embodiments, which may be variously modified without departing from the gist of the present invention.

The present international application claims priority to Japanese Patent Application No. 2022-067329 filed on Apr. 15, 2022, and the entire contents of Japanese Patent Application No. 2022-067329 are incorporated in the present international application by reference.

### REFERENCE SIGNS LIST

1 Screen
2 Light-receiving surface
3 Mirror
4 Support
5 First exposed portion
6 Second exposed portion
7 Light source
8 Mirror array
9 Reflective layer
20 Projector

1. A screen, comprising:
a light-receiving surface at which the screen is configured to receive and reflect projected light in a state in which the screen is placed upright, the light-receiving surface including
a mirror array A in which multiple mirrors A are arranged in a first direction, and
a mirror array B that is positioned in a second direction crossing the first direction and in which multiple mirrors B are arranged in the first direction, and
the mirrors A and the mirrors B are tilted in a same direction at the light-receiving surface.

2. The screen according to claim 1, wherein
the mirror array A, the mirror array B, or both are extended to vicinities of both ends of the light-receiving surface in the first direction.

3. The screen according to claim 1, wherein
in a state in which the mirror array A is positioned at one end in the second direction, and the mirror array B is positioned at another end in the second direction, the another end being opposite to the one end,
a tilt of the mirrors B in the mirror array B is greater than that of the mirrors A in the mirror array A.

4. The screen according to claim 1, wherein
the mirrors A, the mirrors B, or both include a mirror surface disposed at a surface of a support, and
the support is visible in a state in which the light-receiving surface is seen from another end in the second direction, the another end being opposite to one end in the second direction.

5. The screen according to claim 4, wherein
the mirrors positioned at both ends, in the first direction, of the mirror array A, the mirror array B, or both are tilted toward the ends, and
the support is visible in a state in which the light-receiving surface is seen from one end in the first direction.

6. The screen according to claim 1, wherein
the mirrors A, the mirrors B, or both are rectangular.

7. The screen according to claim 1, wherein
the mirrors A and the mirrors B are arranged in a lattice form.

8. The screen according to claim 1, wherein
the mirrors A, the mirrors B, or both are a plane mirror, a concave mirror, or a convex mirror.

9. The screen according to claim 1, wherein
surface areas of the mirrors A, the mirrors B, or both are 300 μm² or more and 4 mm² or less.

10. The screen according to claim 1, wherein
the screen is for a short-throw projector.

11. A die for use in production of the screen according to claim 1, the die comprising:
an imprinting plane array A including multiple imprinting planes A in the first direction, where the multiple imprinting planes A are configured to form planes by imprinting, and the mirrors A are to be disposed on surfaces of the planes; and
an imprinting plane array B including multiple imprinting planes B in the second direction crossing the first direction, where the multiple imprinting planes B are configured to form planes by imprinting, and the mirrors B are to be disposed on surfaces of the planes, wherein
the imprinting planes A and the imprinting planes B are tilted in a same direction.

12. The die according to claim 11, wherein
the die has a roll shape,
the first direction is an axial direction of the die, and
the second direction is a circumferential direction of the die.

13. A production method of a screen, the production method comprising:
imprinting the die of claim 11 to a surface of a base.
